(19) United States
(12) Patent Application Publication
(10) Pub. No.: US 2026/0180422 A1
(43) Pub. Date: Jun. 25, 2026

(54) POWER CONVERTER AND CONTROL METHOD

(71) Applicant: Panasonic Intellectual Property Management Co., Ltd., Osaka (JP)

(72) Inventors: Shinji UJITA, Osaka (JP); Ryusuke KANOMATA, Osaka (JP); Kenichiro TANAKA, Hyogo (JP)

(21) Appl. No.: 19/129,171

(22) PCT Filed: Jun. 27, 2023
(86) PCT No.: PCT/JP2023/023714

§ 371 Date: May 12, 2025

(30) Foreign Application Priority Data
Dec. 1, 2022 (JP) 2022-192846

(51) Int. Cl. H02M 1/00

(52) U.S. Cl. CPC H02M 1/0058

(57) ABSTRACT

A power converter includes two control switches, two synchronous rectifier switches, two inductors, a voltage detector that detects a voltage across one of the control switches, and a controller that controls each switch to shift on and off phases of one of the control switches and one of the synchronous rectifier switches by 180° from on and off phases of the other control switch and the other synchronous rectifier switch. The controller determines the on-time of the target synchronous rectifier switch in accordance with the voltage across the one control switch after a lapse of a predetermined time period since turn-off of the one synchronous rectifier switch, and determines the on-time of the other synchronous rectifier switch as the determined on-time of the target synchronous rectifier switch.

### TECHNICAL FIELD

The present disclosure relates to an interleaved power converter and a method of controlling the interleaved power converter.

### BACKGROUND ART

Patent Literature (PTL) 1 discloses a power converter for performing so-called soft switching (e.g., zero-voltage switching: ZVS).

### CITATION LIST

### Patent Literature

[PTL 1]

Japanese Patent No. 6711123

### SUMMARY OF INVENTION

### Technical Problem

The power converter disclosed in PTL 1 has a single-phase configuration, and it is not assumed that an interleaved power converter with a multiple-phase configuration performs soft switching.

In view of this, the present disclosure provides an interleaved power converter capable of performing soft switching.

### Solution to Problem

A power converter according to one aspect of the present disclosure is a power converter that is an interleaved n-phase power converter, where n is an integer greater than or equal to 2. The power converter includes n circuits, the voltage detector, and the controller. Each of the n circuits includes a control switch provided in a first path that connects a first input/output terminal and a second input/output terminal, a synchronous rectifier switch provided in the first path and connected in series with the control switch, and an inductor provided in a second path that connects a third input/output terminal and a connection node provided in the first path between the control switch and the synchronous rectifier switch. The voltage detector detects a voltage across the control switch, the voltage detector being included in one of the n circuits. The controller controls the control switch and the synchronous rectifier switch in each of the n circuits to shift on and off phases of the control switch and the synchronous rectifier switch in the circuit by 360/n degrees from on and off phases of the control switch and the synchronous rectifier switch in an other of the n circuits. The controller determines an on time of a target synchronous rectifier switch in accordance with the voltage across the control switch and controls the target synchronous rectifier switch according to the on-time determined, the target synchronous rectifier switch being the synchronous rectifier switch in one of the n circuits, the voltage across the control switch being detected by the voltage detector after a lapse of a predetermined time period since turn-off of the synchronous rectifier switch, and determines an on-time of the synchronous rectifier switch in each of the n circuits other than the target synchronous rectifier switch as the on-time of the target synchronous rectifier switch determined, and controls the synchronous rectifier switch in each of the n circuits other than the target synchronous rectifier switch according to the on-time determined.

A control method according to one aspect of the present disclosure is a control method of controlling a power converter that is an interleaved n-phase power converter, where n is an integer greater than or equal to 2. The power converter includes n circuits and a voltage detector. Each of the n circuits includes a control switch provided in a first path that connects a first input/output terminal and a second input/output terminal, a synchronous rectifier switch provided in the first path and connected in series with the control switch, and an inductor provided in a second path that connects a third input/output terminal and a connection node provided in the first path between the control switch and the synchronous rectifier switch. The voltage detector detects a voltage across the control switch, the voltage detector being included in one of the n circuits. The control method includes controlling the control switch and the synchronous rectifier switch in each of the n circuits to shift on and off phases of the control switch and the synchronous rectifier switch in each of the n circuits by 360/n degrees from on and off phases of the control switch and the synchronous rectifier switch in an other of the n circuits, determining an on-time of a target synchronous rectifier switch in accordance with the voltage across the control switch and controlling the target synchronous rectifier switch according to the on-time determined, the target synchronous rectifier switch being the synchronous rectifier switch in one of the n circuits, the voltage across the control switch being detected by the voltage detector after a lapse of a predetermined time period since turn-off of the synchronous rectifier switch, and determining an on-time of the synchronous rectifier switch in each of the n circuits other than the target synchronous rectifier switch as the on-time of the target synchronous rectifier switch determined, and controlling the synchronous rectifier switch in each of the n circuits other than the target synchronous rectifier switch according to the on-time determined.

### Advantageous Effects of Invention

According to one aspect of the present disclosure, it is possible to provide an interleaved power converter capable of performing soft switching.

### BRIEF DESCRIPTION OF DRAWINGS

FIG. 1 is a schematic diagram showing one example of a power converter according to Embodiment 1.

FIG. 2 is a diagram showing the timing of detecting a voltage across a control switch.

FIG. 3 is a diagram for describing that soft switching can be performed for each phase of the power converter according to Embodiment 1.

FIG. 4 is a diagram for describing an adequate on-time of a synchronous rectifier switch.

FIG. 5 is a diagram showing one example of the timing of detecting the voltage across the control switch and the timing of reflecting the determined on-time of the synchronous rectifier switch.

FIG. 6 is a diagram showing one example of the timing of detecting the voltage across the control switch, the timing of calculating the on-time of the synchronous rectifier switch, and the timing of reflecting the determined on-time of the synchronous rectifier switch.

FIG. 7 is a diagram showing another example of the timing of detecting the voltage across the control switch, the timing of calculating the on-time of the synchronous rectifier switch, and the timing of reflecting the determined on-time of the synchronous rectifier switch.

FIG. 8 is a diagram for describing that soft switching is difficult to perform for each phase when constituent elements of the power converter according to Embodiment 1 have varying parameters.

FIG. 9 is a schematic diagram showing one example of a power converter according to Embodiment 2.

FIG. 10 is a diagram for describing that soft switching can be performed for each phase of the power converter according to Embodiment 2.

FIG. 11 is a schematic diagram showing one example of a power converter according to Embodiment 3.

FIG. 12 is a diagram for describing that it is difficult to appropriately perform soft switching for each phase of a power converter according to a comparative example of Embodiment 3.

FIG. 13 is a diagram for describing that soft switching can be appropriately performed for each phase of the power converter according to Embodiment 3.

FIG. 14 is a flowchart showing one example of a control method according to a different embodiment.

### DESCRIPTION OF EMBODIMENTS

Hereinafter, embodiments are described in detail with reference to the drawings.

Note that the embodiments described below are generic or specific examples of the present disclosure. Numerical values, shapes, materials, constituent elements, arrangement positions and connection forms of constituent elements, steps, a sequence of steps, and so on in the following embodiments are merely examples and do not intend to limit the scope of the present disclosure.

### Embodiment 1

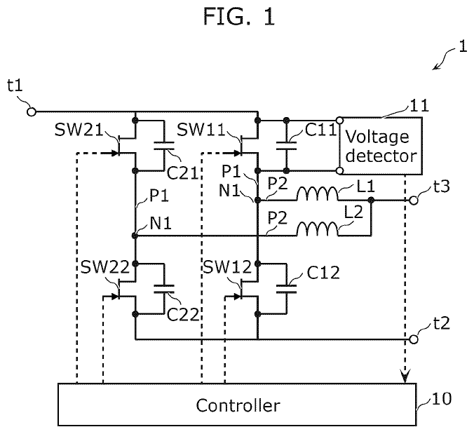

Power converter 1 according to Embodiment 1 is described with reference to FIGS. 1 to 7.

FIG. 1 is a schematic diagram showing one example of power converter 1 according to Embodiment 1.

Power converter 1 is a device that steps up or down an input voltage to a predetermined voltage and outputs the stepped-up or down voltage. Power converter 1 includes input/output terminals t1 to t3. Input/output terminal t1 is one example of a first input/output terminal, input/output terminal t2 is one example of a second input/output terminal, and input/output terminal t3 is one example of a third input/output terminal. In the case where power converter 1 is a step-down converter, input/output terminal t1 serves as an input terminal to which a voltage is input, input/output terminal t2 serves as a ground terminal connected to the ground, and input/output terminal t3 serves as an output terminal from which a voltage is output. In this case, power converter 1 steps down an input voltage applied between input/output terminals t1 and t2 and outputs the stepped-down voltage from input/output terminal t3. In the case where power converter 1 is a step-up converter, input/output terminal t1 serves as a ground terminal connected to the ground, input/output terminal t2 serves as an output terminal from which a voltage is output, and input/output terminal t3 serves as an input terminal to which a voltage is input. In this case, power converter 1 steps up an input voltage applied between input/output terminals t3 and t1 and outputs the stepped-up voltage from input/output terminal t2. Following is a description of an example in which power converter 1 is a step-down converter.

Power converter 1 is an interleaved n-phase power converter, where n is an integer greater than or equal to 2. Power converter 1 includes n circuits each including a control switch provided in path P1 that connects input/output terminals t1 and t2, a synchronous rectifier switch provided in path P1 and connected in series with the control switch, and an inductor provided in path P2 that connects input/output terminal t3 and connection node N1 provided in path P1 between the control switch and the synchronous rectifier switch. Path P1 is one example of a first path, and path P2 is one example of a second path. Power converter 1 further includes a voltage detector that detects a voltage across the control switch in one of the n circuits. For example, power converter 1 may include a voltage detector that detects the voltage across the control switch in only one of the n circuits. Power converter 1 further includes a controller that controls the control switch and the synchronous rectifier switch in each of the n circuits so that on and off phases of the control switch and the synchronous rectifier switch in the circuit are shifted by 360/n degrees from on and off phases of the control switch and the synchronous rectifier switch in any other of the n circuits.

Following is a description of two-phase (n=2) power converter 1. Note that power converter 1 may have three or more phases.

Power converter 1 includes two circuits. One of the two circuits includes switches SW11 and SW12 and inductor L1, and the other of the two circuits includes switches SW21 and SW22 and inductor L2. Power converter 1 further includes controller 10 and voltage detector 11. For example, controller 10 may be realized by a computer (e.g., a microcomputer) that may include a processor and memory.

Switches SW11 and SW21 are one examples of the control switch provided in path P1 that connects input/output terminals t1 and t2. Switches SW12 and SW22 are one examples of the synchronous rectifier switch provided in path P1 and connected in series with the control switch.

Switch SW11 may, for example, be an N-channel metal oxide semiconductor field effect transistor (MOSFET). In FIG. 1, the parasitic capacitance of switch SW11 is indicated by capacitor C11, and capacitor C11 is connected in parallel with switch SW11 in an equivalent circuit. The drain of switch SW11 is connected to input/output terminal t1, and the source of switch SW11 is connected to the drain of switch SW 12. In the case where power converter 1 is a step-up converter, the source of switch SW11 is connected to input/output terminal t1, and the drain of switch SW11 is connected to the source of switch SW12.

Switch SW12 may, for example, be an N-channel MOSFET. In FIG. 1, the parasitic capacitance of switch SW12 is indicated by capacitor C12, and capacitor C12 is connected in parallel with switch SW12 in an equivalent circuit. The drain of switch SW12 is connected to the source of switch SW11, and the source of switch SW12 is connected to input/output terminal t2. In the case where power converter 1 is a step-up converter, the source of switch SW12 is connected to the drain of switch SW11, and the drain of switch SW12 is connected to input/output terminal t2.

Switch SW21 may, for example, be an N-channel MOSFET. In FIG. 1, the parasitic capacitance of switch SW21 is indicated by capacitor C21, and capacitor C21 is connected in parallel with switch SW21 in an equivalent circuit. The drain of switch SW21 is connected to input/output terminal t1, and the source of switch SW21 is connected to the drain of switch SW22. In the case where power converter 1 is a step-up converter, the source of switch SW 21 is connected to input/output terminal t1, and the drain of switch SW21 is connected to the source of switch SW22.

Switch SW22 may, for example, be an N-channel MOSFET. In FIG. 1, the parasitic capacitance of switch SW22 is indicated by capacitor C22, and capacitor C22 is connected in parallel with switch SW22 in an equivalent circuit. The drain of switch SW22 is connected to the source of switch SW21, and the source of switch SW22 is connected to input/output terminal t2. In the case where power converter 1 is a step-up converter, the source of switch SW 22 is connected to the drain of switch SW21, and the drain of switch SW22 is connected to input/output terminal t2.

A control signal from controller 10 is input to the gates of switches SW11, SW12, SW21, and SW22, and the turn-on and turn-off of switches SW11, SW12, SW21, and SW22 are controlled by a control signal that is input to the gates.

Switches SW11 and SW21 have the same electrical characteristics, and capacitors C11 and C21 serving as the parasitic capacitances of switches SW11 and SW21 have the same capacitance (as a nominal value). Switches SW12 and SW22 have the same electrical characteristics, and capacitors C12 and C22 serving as the parasitic capacitances of switches SW12 and SW22 have the same capacitance (as a nominal value). Note that switch SW11 (switch SW21) and switch SW12 (switch SW22) may or may not have the same electrical characteristics.

Inductor L1 is provided in path P2 that connects input/output terminal t3 and connection node N1 provided in path P1 between switches SW11 and SW12. Inductor L2 is provided in path P2 that connects input/output terminal t3 and connection node N1 provided in path P1 between switches SW21 and SW22. Inductors L1 and L2 have the same electrical characteristics and the same inductance (as a nominal value).

Voltage detector 11 may, for example, be included in the circuit that includes switches SW11 and SW12 and inductor L1, and detect a voltage across switch SW11 (a voltage applied to capacitor C11). Details of voltage detector 11 will be described later.

Controller 10 controls the control switch and the synchronous rectifier switch in each of the two circuits so that on and off phases of the control switch and the synchronous rectifier switch in each of the two circuits are shifted by 180° ((360/2 )°) from on and off phases of the control switch and the synchronous rectifier switch in the other of the two circuits. Specifically, switches SW11, SW12, SW21, and SW22 are controlled so that the on and off phases of switches SW11 and SW12 are shifted by 180°from the on and off phases of switches SW21 and SW22. More specifically, controller 10 controls switches SW11, SW12, SW21, and SW22 so that the timing of turning on switch SW11 and the timing of turning on switch SW21 are shifted by 180°, the timing of turning off switch SW11 and the timing of turning off switch SW21 are shifted by 180°, the timing of turning on switch SW12 and the timing of turning on switch SW22 are shifted by 180°, and the timing of turning off switch SW12 and the timing of turning off switch SW22 are shifted by 180°. In this way, power converter 1 realizes interleave operations.

There is increasing demand for downsizing of power converters such as vehicle-mounted battery rechargers and AC adapters. In particular, there is increasing demand for downsizing of passive components such as inductors and capacitors that occupy most of the size of the power converter. In the case of downsizing passive components, if driving frequencies of the switches are set to be the same as those of the switches before downsizing of the passive components, current ripple will increase and it becomes necessary to drive a power converter at high frequencies. Meanwhile, high-frequency drive causes switching losses every time switching is performed, and therefore soft switching becomes necessary.

Patent Literature 1 describes the power converter with a single-phase configuration for performing soft switching (e.g., zero-voltage switching), but fails to assume a case in which an interleaved power converter with a multiple-phase configuration performs soft switching.

In contrast, the present disclosure allows even interleaved power converter 1 with a multiple-phase configuration to perform soft switching by causing controller 10 to perform the following operations.

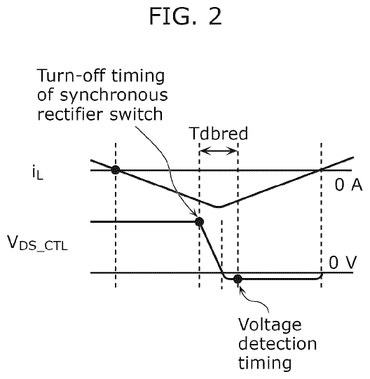

Controller 10 determines the on-time of a target synchronous rectifier switch that is the synchronous rectifier switch in one of the two circuits, in accordance with the voltage across the control switch (e.g., switch SW11) detected by voltage detector 11 after a lapse of a predetermined time period since turn-off of the synchronous rectifier switch (e.g., switch SW12), controls the target synchronous rectifier switch according to the determined on-time, determines the on-time of the synchronous rectifier switch in the other of the two circuits other than the target synchronous rectifier switch as the determined on-time of the target synchronous rectifier switch, and controls the synchronous rectifier switch in the other of the two circuits other than the target synchronous rectifier switch according to the determined on-time. There are no particular limitations on the target synchronous rectifier switch, and the target synchronous rectifier switch may be the synchronous rectifier switch in the circuit that includes voltage detector 11, i.e., switch SW12, or may be the synchronous rectifier switch in the circuit that does not include voltage detector 11, i.e., switch SW22. Here, the target synchronous rectifier switch is assumed to be switch SW12. In this case, the synchronous rectifier switch other than the target synchronous rectifier switch is switch SW22. Here, the timing of detecting the voltage across the control switch is described with reference to FIG. 2.

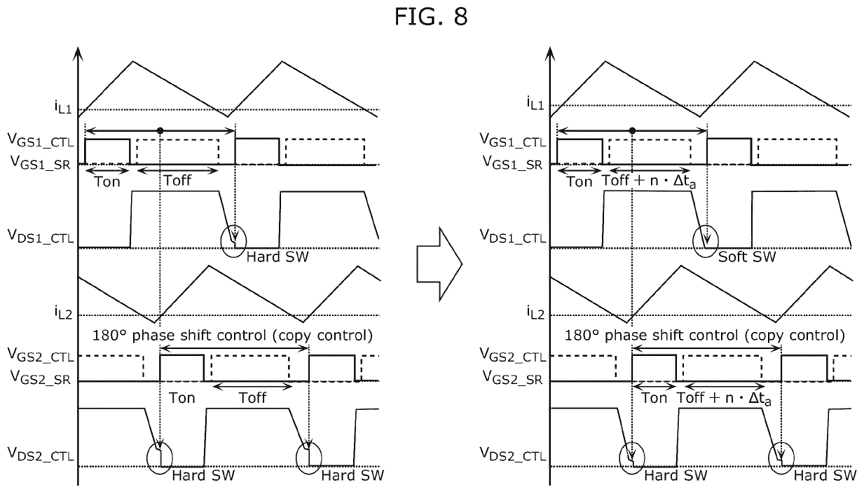

FIG. 2 is a diagram showing the timing of detecting the voltage across the control switch, where i_{L} denotes the current flowing through the inductor (e.g., inductor L1), and V_{DS_CTL} denotes the drain-source voltage of the control switch (e.g., switch SW11) (i.e., the voltage across the control switch). In the graphs shown in FIG. 2 and FIGS. 8, 10, 12, and 13 described later, the horizontal axis indicates the time base.

The timing of detecting the voltage across the control switch is the timing after a lapse of a predetermined time period since turn-off of the synchronous rectifier switch. In FIG. 2, the predetermined time period is indicated by Tdbred. The predetermined time period is a period that the control switch and the synchronous rectifier switch are in the off state, a negative current is flowing through the inductor, and resonance is produced by the inductance of the inductor, the capacitance across the control switch, and the capacitance across the synchronous rectifier switch (e.g., the capacitances of capacitors C11 and C12). FIG. 2 shows the timing of turning off the synchronous rectifier switch which is the start timing of the predetermined time period. After this timing, the control switch and the synchronous rectifier switch are in the off state, a negative current is flowing through the inductor, and the aforementioned resonance is produced so that the voltage across the control switch starts stepping down. The predetermined time period is set as appropriate and is shorter than a time period from turn-off of the synchronous rectifier switch to turn-on of the control switch.

For example, in the case where voltage detector 11 has detected that the voltage across the control switch after a lapse of the predetermined time period since turn-off of the synchronous rectifier switch is greater than a predetermined threshold value, controller 10 determines the on-time of the target synchronous rectifier switch to be longer than the current on-time. Specifically, in the case where voltage detector 11 has detected that the voltage across switch SW11 after a lapse of the predetermined time period since turn-off of switch SW12 is greater than the predetermined threshold value, controller 10 determines the on-time of switch SW12 to be longer than the current on-time. The predetermined threshold value may, for example, be 0V, but it may not strictly be 0V and may be a value about 0V.

For example, in the case where voltage detector 11 has detected that the voltage across the control switch after a lapse of the predetermined time period since turn-off of the synchronous rectifier switch is less than or equal to the predetermined threshold value, controller 10 determines the on-time of the target synchronous rectifier switch to be shorter than the current on-time. Specifically, in the case where voltage detector 11 has detected that the voltage across switch SW11 after a lapse of the predetermined time period since turn-off of switch SW12 is less than or equal to the predetermined threshold value, controller 10 determines the on-time of switch SW12 to be shorter than the current on-time.

The period that the negative current is flowing through inductor L1 changes depending on the on-time of switch SW12, and the amount of the step-down of the voltage across switch SW11 during the off state of switches SW11 and SW12 is determined by the period that the negative current is flowing through inductor L1. Thus, if the length of the on-time of switch SW12 is adjusted and determined depending on whether the voltage across switch SW11 after a lapse of the predetermined time period since switch SW12 has transitioned from the on state to the off state has stepped down to a target voltage (e.g., 0V), switch SW11 can be turned on when the voltage across switch SW11 is at the target voltage (e.g., 0V), i.e., soft switching is realized.

In the case where the voltage across switch SW11 after a lapse of the predetermined time period since turn-off of switch SW12 is greater than the predetermined threshold value, switch SW11 is in a hard switching state, and therefore soft switching can be realized by elongating the on-time of switch SW12. In the case where the voltage across switch SW11 after the lapse of the predetermined time period since the turn-off of switch SW12 is less than or equal to the predetermined threshold value, switch SW11 is in a soft switching state, but a large negative current flows through inductor L1 and efficiency may decline. Thus, in this case, the on-time of switch SW12 is shortened so as to suppress a decline in efficiency caused by an increase in the negative current.

It is, however, noted that the two-phase power converter needs to maintain a phase shift of a fixed angle between the two circuits (e.g., 180° in the case of the two-phase power converter). For example, in the case where the on-time of the synchronous rectifier switch in each of the two circuits is determined independently, soft switching can be realized in each of the two circuits, but it is difficult to maintain a phase shift of a fixed angle between the two circuits, and accordingly interleave operations are difficult to realize.

In contrast, according to the present disclosure, the on-time of the target synchronous rectifier switch (e.g., switch SW12) in one of the two circuits is determined, and the determined on-time is also applied to the synchronous rectifier switch (e.g., switch SW22) other than the target synchronous rectifier switch. Specifically, controller 10 determines the on-time of switch SW12 and applies the determined on-time to all of the synchronous rectifier switches included in power converter 1 (i.e., switches SW12 and SW22). Accordingly, the on-time of the synchronous rectifier switch in each of the two circuits changes by the same amount, and it is possible to maintain a phase shift of a fixed angle between the two circuits.

Since controller 10 controls switches SW11, SW12, SW21, and SW22 so that the on and off phases of switches SW11 and SW12 are shifted by 180° from the on and off phases of switches SW21 and SW22, the phase shift of a fixed angle (e.g., 180°) between the two circuits is maintained even after the determined on-time is applied to switches SW12 and SW22.

In order to allow controller 10 to determine whether voltage detector 11 has detected that the voltage across the control switch after a lapse of the predetermined time period since turn-off of the synchronous rectifier switch is greater than the predetermined threshold value, voltage detector includes the following constituent elements. Specifically, voltage detector 11 includes a trigger signal generator that generates a trigger signal after the lapse of the predetermined time period since the turn-off of the synchronous rectifier switch, a dead-time detection signal generator that generates a dead-time detection signal when the voltage across the control switch is less than or equal to a predetermined threshold value, and an outputter that outputs a soft-switch detection signal for determining the on-time of the synchronous rectifier switch in accordance with the trigger signal and the dead-time detection signal. Each function of voltage detector 11 may be realized by, for example, a clamp circuit, a comparator, a digital isolator, and a logic IC, or may be realized by, for example, a diode detection circuit, a photocoupler, and a logic IC. The functions of voltage detector 11 may also be realized by a computer (e.g., a microcomputer) that may include a processor and memory.

For example, in the case where the dead-time detection signal is generated with the timing of generation of the trigger signal, voltage detector 11 detects that the voltage across the control switch after a lapse of the predetermined time period since turn-off of the synchronous rectifier switch is less than or equal to the predetermined threshold value, and outputs a soft-switch detection signal. Upon receipt of the soft-switch detection signal, controller 10 can determine that voltage detector 11 has detected that the voltage across the control switch after the lapse of the predetermined time period since the turn-off of the synchronous rectifier switch is less than or equal to the predetermined threshold value.

For example, in the case where the dead-time detection signal is not generated with the timing of generation of the trigger signal, voltage detector 11 detects that the voltage across the control switch after a lapse of the predetermined time period since turn-off of the synchronous rectifier switch is greater than the predetermined time period, and does not output a soft-switch detection signal. When a soft-switch detection signal is not received, controller 10 can determine that voltage detector 11 has detected that the voltage across the control switch after the lapse of the predetermined time period since the turn-off of the synchronous rectifier switch is greater than the predetermined threshold value.

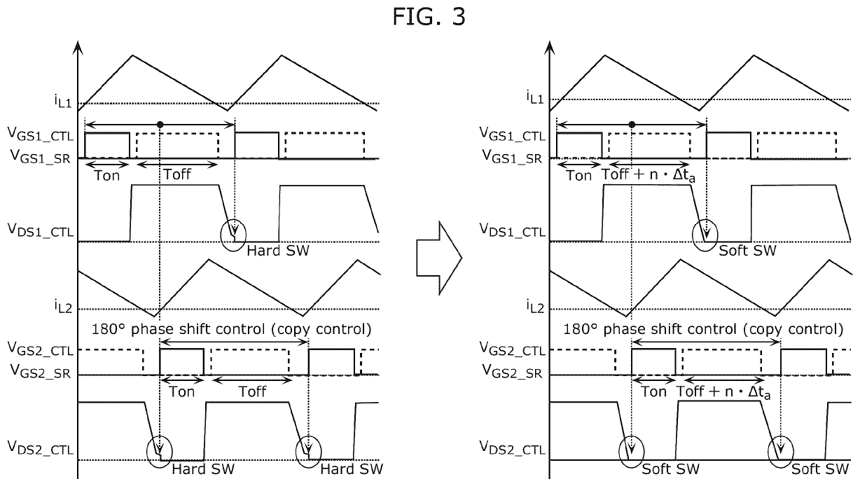

Here, the ability of power converter 1 to perform soft switching for each phase is described in detail with reference to FIG. 3.

FIG. 3 is a diagram for describing that soft switching can be performed for each phase of power converter 1 according to Embodiment 1. Here, i_{L1} denotes the current flowing through inductor L1, V_{GS1_CTL} (solid line) denotes the gate-source voltage of switch SW11 (i.e., turn-on and turn-off of switch SW11), V_{GS1_SR} (broken line) denotes the gate-source voltage of switch SW12 (i.e., turn-on and turn-off of switch SW12), and V_{DS1_CTL} denotes the drain-source voltage of switch SW11 (i.e., the voltage across switch SW11). Also, i_{L2} denotes the current flowing through inductor L2, V_{GS2_CTL} (solid line) denotes the gate-source voltage of switch SW21 (i.e., turn-on and turn-off of switch SW21), V_{GS2_SR} (broken line) denotes the gate-source voltage of switch SW22 (i.e., turn-on and turn-off of switch SW22), and V_{DS2_CTL} denotes the drain-source voltage of switch SW21 (i.e., the voltage across switch SW21). Moreover, Ton denotes the on-times of switches SW11 and SW21, Toff denotes the off-times of switches SW11 and SW21, i.e., the on-times of switches SW12 and SW22, and Toff+n·ΔTₐ denotes the adjusted on-times of switches SW12 and SW22. The same applies to FIGS. 8, 10, 12, and 13 described later.

As shown on the left side in FIG. 3, a case is assumed in which the voltages across switches SW11 and SW21 have not yet stepped down to a predetermined threshold value (e.g., 0V) when switches SW11 and SW21 are turned on, and accordingly switches SW11 and SW21 are in a hard switching state.

Since voltage detector 11 has detected that the voltage across switch SW11 after a lapse of the predetermined time period since turn-off of switch SW12 is greater than the predetermined threshold value, controller 10 determines the on-time of switch SW12 to be longer than the current on-time. Controller 10 also determines the on-time of switch SW22 as the determined on-time of switch SW12. That is, controller 10 determines the on-time of switch SW22 as the on-time of switch SW12 that is determined to be longer than the current on-time. There are no particular limitations on the amount of increase in the on-time (ATa) with respect to the current on-time, but the amount of increase is set to be small to some extent because if the amount of increase is large, the period that the negative current flows through the inductor may become too long. For example, turn-on and turn-off of each switch is controlled according to the determined on-time, and if the switches are not in a soft switching state, the on-times of the switches are increased by the same amount. By repeating this processing and gradually increasing the on-times in increments of ΔTₐ, each switch can enter a soft switching state.

This enables transition from the state as shown on the left side in FIG. 3 in which the on-times of switches SW12 and SW22 are indicated by Toff and switches SW11 and SW21 are in a hard switching state to the state as shown on the right side in FIG. 3 in which the on-times of switches SW12 and SW22 are indicated by Toff+n·ΔTₐ and switches SW11 and SW21 are in a soft switching state. In the on-time, n denotes the number of times that ΔTₐ is added. In this way, the on-times of switches SW12 and SW22 are set to adequate on-times, and switches SW11 and SW21 can enter a soft switching state.

In the case where the current on-time is long and the period that the negative current flows through the inductor is also long, the period that the negative current flows can be set to an adequate period by gradually shortening the on-time in the same manner as described above.

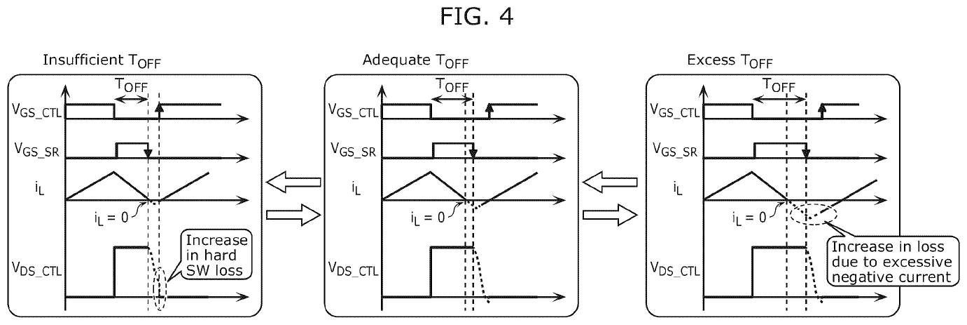

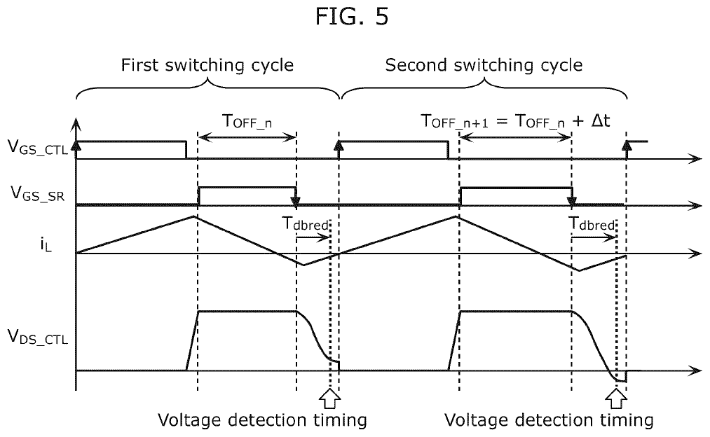

FIG. 4 is a diagram for describing an adequate on-time of a synchronous rectifier switch. Here, V_{GS_CTL} denotes the gate-source voltage of the control switch (i.e., turn-on and turn-off of the control switch), V_{GS_SR} denotes the gate-source voltage of the synchronous rectifier switch (i.e., turn-on and turn-off of the synchronous rectifier switch), i_{L} denotes the current flowing through the inductor, and V_{DS_CTL} denotes the drain-source voltage of the control switch (i.e., the voltage across the control switch). The same applies to FIGS. 5 to 7 described later. Moreover, TOFF denotes the on-time of the synchronous rectifier switch.

As shown on the left side in FIG. 4, in the case where the on-time of the synchronous rectifier switch is too short, losses will increase because the period that the negative current flows through the inductor is short and the control switch is in a hard switching state. In view of this, as shown in the center in FIG. 4, the on-time is elongated so that the control switch can enter a soft switching state. As shown on the right side in FIG. 4, in the case where the on-time of the synchronous rectifier switch is too long, the control switch can enter a soft switching state, but the period that the negative current flows through the inductor is long and accordingly losses will increase due to an excessive amount of negative current. In view of this, as shown in the center in FIG. 4, the on-time is shortened so that the control switch can enter an optimum soft switching state. Note that if the conditions of the input and output voltages change while the on-time of the synchronous rectifier switch is adequate, losses may increase because the control switch enters a hard switching state as shown on the left side in FIG. 4 or the period that the negative current flows through the inductor becomes long as shown on the right side in FIG. 4. In that case, the on-time is adjusted again autonomously to bring about a state as shown in the center in FIG. 4.

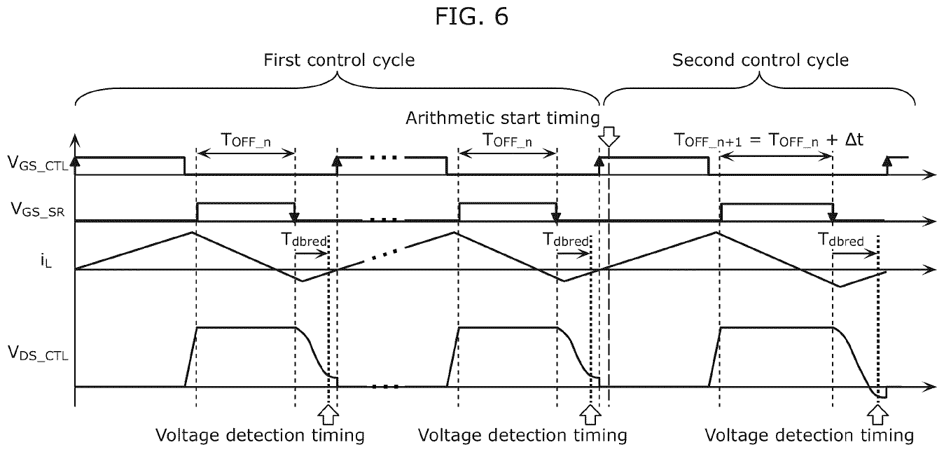

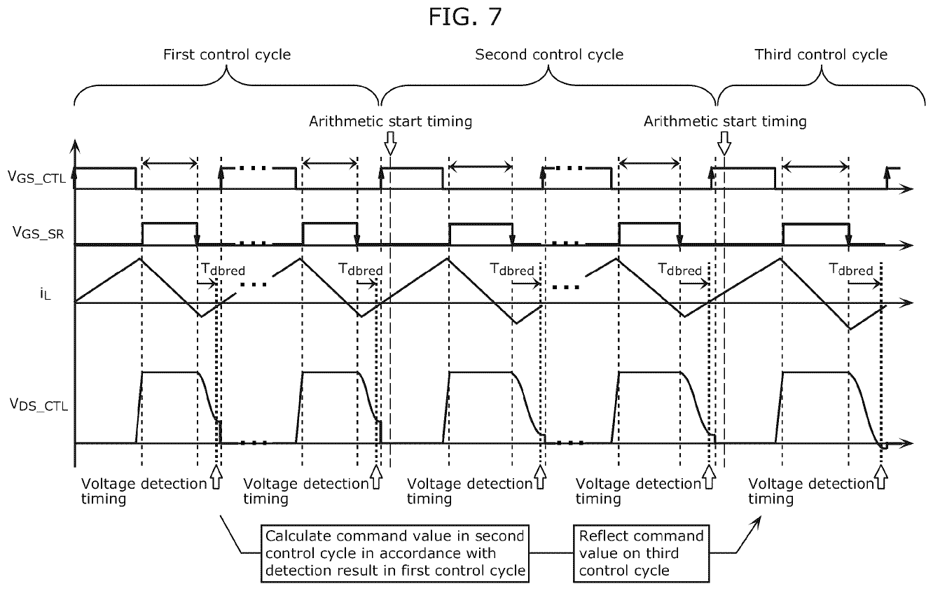

Next, one example of the timing of detecting the voltage across the control switch and the timing of reflecting the determined on-time of the synchronous rectifier switch is described with reference to FIG. 5. Moreover, two examples of the timing of detecting the voltage across the control switch, the timing of calculating the on-time of the synchronous rectifier switch, and the timing of reflecting the determined on-time of the synchronous rectifier switch are described with reference to FIGS. 6 and 7.

FIG. 5 is a diagram showing one example of the timing of detecting the voltage across the control switch and the timing of reflecting the determined on-time of the synchronous rectifier switch.

In the example shown in FIG. 5, a period from turn-on of the control switch to the next turn-on of the control switch is defined as one switching cycle of the control switch, and a first switching cycle and a second switching cycle immediately after the first switching cycle are shown from among repeated switching cycles. Here, TOFF_n denotes the on-time of the synchronous rectifier switch in the first switching cycle, and T_{OFF_n+1} denotes the on-time of the synchronous rectifier switch in the second switching cycle. The timing of detecting the voltage across the control switch in each switching cycle is when a predetermined time period (Tdbred) has elapsed since turn-off of the synchronous rectifier switch.

In the example shown in FIG. 5, controller 10 determines the on-time of a target synchronous rectifier switch in the second switching cycle immediately after the first switching cycle in accordance with a detection result obtained in the first switching cycle by voltage detector 11. That is, the result of detecting the voltage across the control switch in the first switching cycle is reflected on the on-time of the target synchronous rectifier switch in the second switching cycle immediately after the first switching cycle (and, by extension, the on-times of all of the synchronous rectifier switches).

In this way, the detection result is reflected on the next switching cycle immediately after the switching cycle of voltage detection (i.e., the on-time determined based on the detection result is applied to all of the synchronous rectifier switches). This improves the response speed.

In the example shown in FIG. 5, controller 10 determines the on-time of the target synchronous rectifier switch in the second switching cycle by adding a first correction amount to the on-time of the target synchronous rectifier switch in the first switching cycle. In the example shown in FIG. 5, on-time T_{OFF_n+1} of the target synchronous rectifier switch in the second switching cycle is determined by adding first correction amount Δt to on-time T_{OFF_n} of the target synchronous rectifier switch in the first switching cycle. In the second switching cycle as well, if the result of detecting the voltage across the control switch is greater than a predetermined threshold value, on-time T_{OFF_n+2} of the target synchronous rectifier switch in a third switching cycle immediately after the second switching cycle becomes T_{OFF_n}+2·Δt. In this way, the on-time is gradually changed by adding the first correction amount in each switching cycle, so that the on-time becomes an optimum period.

FIG. 6 is a diagram showing one example of the timing of detecting the voltage across the control switch, the timing of calculating the on-time of the synchronous rectifier switch, and the timing of reflecting the determined on-time of the synchronous rectifier switch.

In the example shown in FIG. 6, a period from turn-on of the control switch to the next turn-on of the control switch is defined as one switching cycle of the control switch, one cycle that includes a plurality of switching cycles is defined as one control cycle, and a first control cycle and a second control immediately after the first control cycle are shown from among repeated control cycles. Here, T_{OFF_n} denotes the on-time of the synchronous rectifier switch in the first control cycle, and T_{OFF_n+1} denotes the on-time of the synchronous rectifier switch in the second control cycle. The timing of detecting the voltage across the control switch in each control cycle is when a predetermined time period (Tdbred) has elapsed since turn-off of the synchronous rectifier switch in each switching cycle.

In the example shown in FIG. 6, controller 10 determines the on-time of the target synchronous rectifier switch in the second control cycle immediately after the first control cycle in accordance with a detection result obtained in the first control cycle by voltage detector 11. That is, the result of detecting the voltage across the control switch in the first control cycle is reflected on the on-time of the synchronous rectifier switch in the second control cycle. Specifically, the result of detecting the voltage across the control switch in the last switching cycle of the first control cycle is used in an arithmetic operation for determining the on-time of the synchronous rectifier switch in the second control cycle, and this arithmetic operation is conducted with the timing of starting the first switching cycle of the second control cycle. That is, the result of detecting the voltage across the control switch the first control cycle is used in the arithmetic operation for determining the on-time of the target synchronous rectifier switch in the second control cycle immediately after the first control cycle, and is reflected on the on-time of the target synchronous rectifier switch in the second control cycle (and, by extension, the on-times of all of the synchronous rectifier switches).

In this way, the detection result is reflected on the next control cycle immediately after the control cycle of voltage detection (i.e., the on-time determined based on the detection result is applied to all of the synchronous rectifier switches). This improves the response speed.

In the example shown in FIG. 6, controller 10 determines the on-time of the target synchronous rectifier switch in the second control cycle by adding the first correction amount to the on-time of the target synchronous rectifier switch in the first control cycle. In the example shown in FIG. 6, on-time T_{OFF_n+1} of the target synchronous rectifier switch in the second control cycle is determined by adding first correction amount Δt to on-time T_{OFF_n} of the target synchronous rectifier switch in the first control cycle. In the second control cycle as well, if the result of detecting the voltage across the control switch is greater than a predetermined threshold value, on-time T_{OFF_n+2} of the target synchronous rectifier switch in the third control cycle immediately after the second control cycle becomes T_{OFF_n}+2·Δt. In this way, the on-time is gradually changed by adding the first correction amount in each control cycle, so that the on-time becomes an optimum period.

FIG. 7 is a diagram showing another example of the timing of detecting the voltage across the control switch, the timing of calculating the on-time of the synchronous rectifier switch, and the timing of reflecting the determined on-time of the synchronous rectifier switch.

In the example shown in FIG. 7, a period from turn-on of the control switch to the next turn-on of the control switch is defined as one switching cycle of the control switch, and a cycle that includes a plurality of switching cycles is defined as one control cycle, and a first control cycle, a second control cycle immediately after the first control cycle, and a third control cycle immediately after the second control cycle are shown from among repeated control cycles. The timing of detecting the voltage across the control switch in each control cycle is when a predetermined time period (Tdbred) has elapsed since turn-off of the synchronous rectifier switch in each switching cycle.

In the example shown in FIG. 7, in the second control cycle immediately after the first control cycle, controller 10 performs an arithmetic operation for determining the on-time of the target synchronous rectifier switch in the third control cycle immediately after the second control cycle in accordance with the detection result obtained in the first control cycle by voltage detector 11. That is, a command value is calculated in the second control cycle in accordance with the detection result obtained in the first control cycle, and the calculated command value is reflected on the on-time of the synchronous rectifier switch in the third control cycle.

In this way, the arithmetic operation for reflecting the detection result on the next control cycle is performed in the next control cycle immediately after the control cycle of voltage detection. This ensures a sufficient amount of arithmetic time.

In the example shown in FIG. 7, controller 10 determines the on-time of the target synchronous rectifier switch in the third control cycle by adding the first correction amount to the on-time of the target synchronous rectifier switch in the first control cycle.

As described above, the on-time of the target synchronous rectifier switch in one of the n circuits is determined, and the determined on-time is also applied to the synchronous rectifier switches other than the target synchronous rectifier switch. Thus, the on-time of the synchronous rectifier switch in each of the n circuits changes by the same amount, and it is possible to maintain a phase shift of a fixed angle among the n circuits. Therefore, soft switching can be performed for each of the n circuits while maintaining a phase shift of a fixed angle among the n circuits. Accordingly, it is possible to provide interleaved power converter 1 capable of performing soft switching.

### Embodiment 2

In the n-phase power converter, for example, the n circuits use switches with parasitic capacitances of the same nominal value and inductors with inductances of the same nominal value. However, these parameters such as parasitic capacitances and inductances may vary even if they have the same nominal values. According to Embodiment 1, the on-time determined based on the voltage across switch SW11, detected by voltage detector 11, is applied to the on-times of switches SW12 and SW22. Thus, if these parameters vary, soft switching may not be able to be realized in circuits other than the circuit that includes voltage detector 11. This is described with reference to FIG. 8.

FIG. 8 is a diagram for describing that soft switching is difficult to perform for each phase when the constituent elements of power converter 1 according to Embodiment 1 have varying parameters. For example, in FIG. 8, a case is assumed in which the inductance of inductor L2 is greater than the inductance of inductor L1 by an amount equivalent to a maximum tolerance, and the capacitances of capacitors C11 and C12 are greater than the capacitances of capacitors C21 and C22 by an amount equivalent to a maximum tolerance. Thus, the voltage across switch SW21 after a lapse of a predetermined time period since turn-off of switch SW22 is greater than the voltage across switch SW11 after a lapse of the predetermined time period since turn-off of switch SW12.

As shown in FIG. 8, in the circuit that includes voltage detector 11, the on-time of switch SW 12 is determined based on the voltage across switch SW11, so that switch SW11 can enter a soft switching state. Meanwhile, in the circuit that does not include voltage detector 11, the on-time of switch SW 22 is determined based not on the voltage across switch SW21, but on the voltage across switch SW11. However, switch SW21 remains in a hard switching state because, during the on-time of switch SW22 determined based on the voltage across switch SW11, the negative current flows for only a short period and fails to step down the voltage across switch SW21 enough.

In this way, when the constituent elements of power converter 1 have varying parameters (the inductances of the inductors or the capacitances of the parasitic capacitances), it may be difficult to perform soft switching for each phase.

In view of this, Embodiment 2 describes a power converter that is capable of performing soft switching for each phase even if the constituent elements of the power converter have varying parameters.

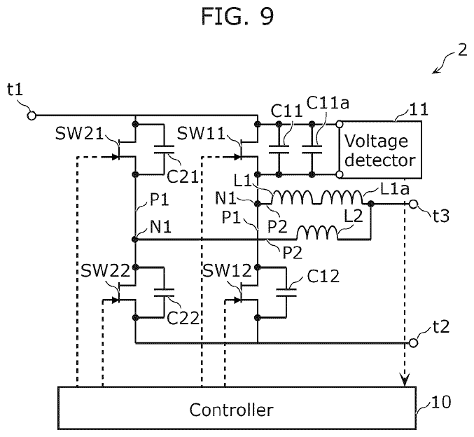

FIG. 9 is a schematic diagram showing one example of power converter 2 according to Embodiment 2.

Power converter 2 according to Embodiment 2 is different from power converter 1 according to Embodiment 1 in that it includes capacitor C11a and inductor L1a. In the other respects, it is the same as that described in Embodiment 1, and therefore a description thereof is omitted.

Power converter 2, like power converter 1, includes voltage detector 11 in only one of the n circuits.

In Embodiment 2, the capacitance across switch SW11 in the circuit that includes voltage detector 11 is greater than the capacitance of switch SW21 in the circuit that does not include voltage detector 11 by an amount equivalent to a maximum variation tolerance of the capacitance of switch SW21. For example, as shown in FIG. 9, the circuit that includes voltage detector 11 may further include capacitor C11a that is an additional capacitor connected in parallel with switch SW11, and capacitor C11a has a capacitance equivalent to a maximum variation tolerance of the parasitic capacitance of the control switch in the circuit that does not include voltage detector 11 (i.e., the capacitance of capacitor C21). This allows the capacitance across switch SW11 to become greater than the capacitance across switch SW21 by the amount equivalent to the maximum variation tolerance of the parasitic capacitance of switch SW21. For example, in the case where the capacitance of capacitor C21 (as a nominal value) is 100 pF and the maximum variation tolerance is 10% (i.e., the capacitance of capacitor C2 is 100 pF±5 pF), the capacitance of capacitor C11a is 10 pF.

Note that power converter 2 does not necessarily have to include capacitor C11a, and the capacitance of capacitor C11 (as a nominal value) may be greater than the capacitance of capacitor C21 (as a nominal value) by an amount equivalent to the maximum variation tolerance of the capacitance of capacitor C21. Even in this case, the capacitance across switch SW11 can be made greater than the capacitance across switch SW21 by the amount equivalent to the maximum variation tolerance of the parasitic capacitance of switch SW21.

The inductance in path P2 of the circuit that includes voltage detector 11 is greater than the inductance in path P2 of the circuit that does not include voltage detector 11 by an amount equivalent to a maximum variation tolerance of the inductance of inductor L2. For example, as shown in FIG. 9, the circuit that includes voltage detector 11 may further include inductor L1a that is an additional inductor provided in path P2 and connected in series with inductor L1, and inductor L1a may have an inductance equivalent to the maximum variation tolerance of the inductance of inductor L2 in the circuit that does not include voltage detector 11. This allows the inductance in path P2 of the circuit that includes voltage detector 11 to become greater than the inductance in path P2 of the circuit that does not include voltage detector 11 by the amount equivalent to the maximum variation tolerance of the inductance of inductor L2. For example, in the case where the inductance of inductor L2 (as a nominal value) is 1 pH and the maximum variation tolerance is 10% (i.e., the capacitance of the inductance of inductor L2 is 1 pH±0.05 μH), the inductance of inductor L1a becomes 0.1 μH.

Note that power converter 2 does not necessarily have to include inductor L1a, and the inductance of inductor L1 (as a nominal value) may be greater than the inductance of inductor L2 (as a nominal value) by the amount equivalent to the maximum variation tolerance of inductor L2. Even in this case, the inductance in path P2 of the circuit that includes voltage detector 11 can be made greater than the inductance in path P2 of the circuit that does not include voltage detector 11 by the amount equivalent to the maximum variation tolerance of the inductance of inductor L2.

Note that it is not essential to satisfy both of the following conditions: the condition that the capacitance across switch SW11 in the circuit that includes voltage detector 11 is greater than the capacitance across switch SW21 in the circuit that does not include voltage detector 11 by the amount equivalent to the maximum variation tolerance of the parasitic capacitance of switch SW21, and the condition that the inductance in path P2 of the circuit that includes voltage detector 11 is greater than the inductance in path P2 of the circuit that does not include voltage detector 11 by the amount equivalent to the maximum variation tolerance of the inductance of inductor L2.

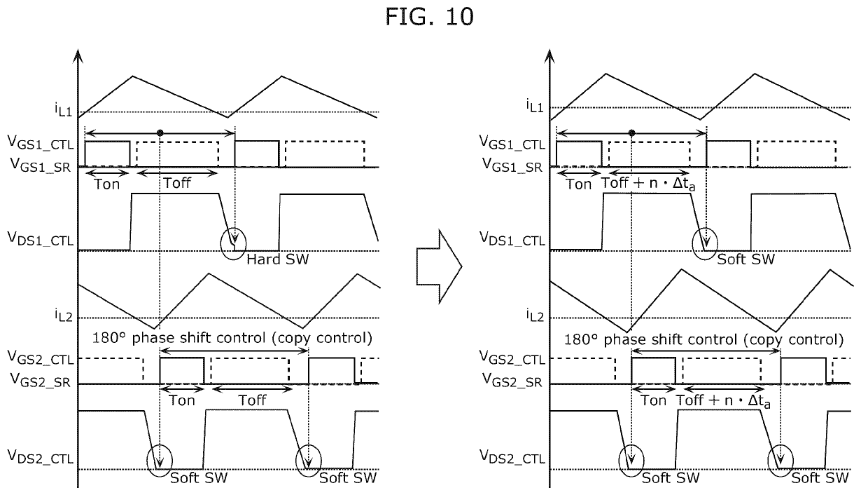

FIG. 10 is a diagram for describing that soft switching can be performed for each phase of power converter 2 according to Embodiment 2.

As shown on the left side in FIG. 10, a case is assumed in which, when switch SW11 is turned on, the voltage across switch SW11 has not yet stepped down to a predetermined threshold value (e.g., 0V), and therefore switch SW11 is in a hard switching state. At this time, when switch SW21 is turned on, the voltage across switch SW21 has stepped down to the predetermined threshold value (e.g., 0V), so that switch SW21 is in a soft switching state. This is because the period that the negative current flows through inductor L1 in the circuit that includes voltage detector 11 is shorter than in the circuit that does not include voltage detector 11, and therefore switch SW11 in the circuit that includes voltage detector 11 is prone to enter a hard switching state, whereas switch SW21 in the circuit that does not include voltage detector 11 is hard to enter a hard switching state.

Since voltage detector 11 has detected that the voltage across switch SW11 after a lapse of the predetermined time period since turn-off of switch SW12 is greater than the predetermined threshold value, controller 10 determines the on-time of switch SW12 to be longer than the current on-time. Controller 10 also determines the on-time of switch SW22 as the determined on-time of switch SW12. That is, controller 10 determines the on-time of switch SW 22 as the on-time of switch SW12 that is determined to be longer than the current on-time. In the case in the circuit that does not include voltage detector 11, losses are caused due to an excessive increase in the period that the negative current flows through inductor L2, but the influence caused by such losses is smaller than the influence caused by losses caused while the switch is in a hard switching state. Therefore, in order to reliably perform soft switching for each phase, the circuit that includes voltage detector 11 is made prone to enter a hard switching state.

As described above, the control switch that includes voltage detector 11 is made prone to enter a hard switching state, and the on-times of all of the synchronous rectifier switches are determined based on the voltage across the control switch that is prone to enter a hard switching state. Therefore, even if the constituent elements of power converter 2 have varying parameters, it is possible to perform soft switching in each of the n circuits.

### Embodiment 3

Although Embodiments 1 and 2 have described examples in which the power converter includes voltage detector 11 in only one of the n circuits, the present disclosure is not limited to these examples. Embodiment 3 describes an example in which the power converter includes a voltage detector in each of the n circuits.

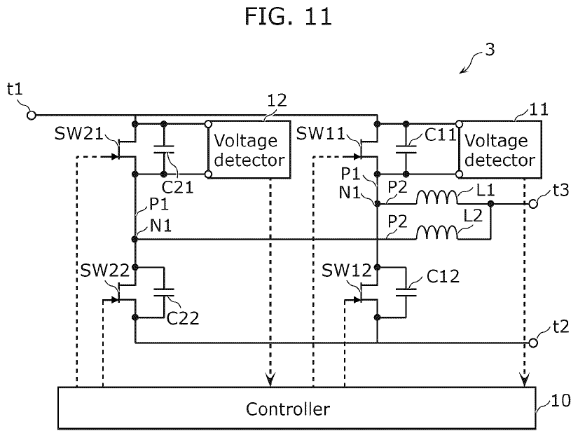

FIG. 11 is a schematic diagram showing one example of power converter 3 according to Embodiment 3.

Power converter 3 according to Embodiment 3 is different from power converter 1 according to Embodiment 1 in that it further includes voltage detector 12. In the other respects, it is the same as that described in Embodiment 1, and therefore a description thereof is omitted.

Voltage detector 12 is included in the circuit that includes switches SW21 and SW22 and inductor L2, and detects the voltage across switch SW21 (the voltage applied to capacitor C21). For example, voltage detector 12 may include a trigger signal generator that generates a trigger signal after a lapse of a predetermined time period since turn-off of switch SW22, a dead-time detection signal generator that generates a dead-time detection signal when the voltage across switch SW21 is less than or equal to a predetermined threshold value, and an outputter that outputs a soft-switch detection signal for determining the on-time of switch SW22 in accordance with the trigger signal and the dead-time detection signal.

Thus, in the case where voltage detector 11 or 12 has detected that the voltage across the control switch after a lapse of the predetermined time period since turn-off of the synchronous rectifier switch is greater than the predetermined threshold value, controller 10 determines the on-time of the target synchronous rectifier switch to be longer than the current on-time. In the case where voltage detector 11 or 12 has detected that the voltage across the control switch after the lapse of the predetermined time period since the turn-off of the synchronous rectifier switch is less than or equal to the predetermined threshold value, controller 10 determines the on-time of the target synchronous rectifier switch to be shorter than the current on-time.

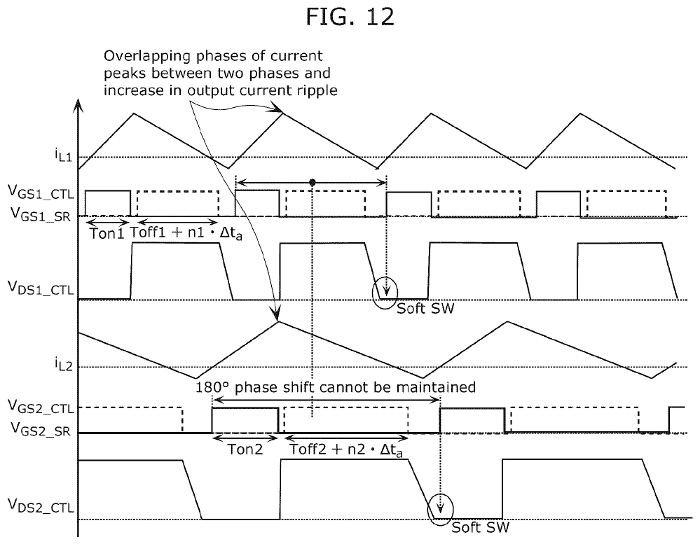

Here, a power converter according to a comparative example in which on-times are determined independently for each phase is described with reference to FIG. 12. Note that the circuit configuration of the power converter according to the comparative example is the same as that shown in FIG. 11, and therefore illustration thereof is omitted.

FIG. 12 is a diagram for describing that it is difficult to appropriately perform soft switching for each phase of the power converter according to the comparative example of Embodiment 3.

In the power converter according to the comparative example, on-times are determined independently for each phase. Specifically, the on-time of switch SW12 is determined based on the voltage across switch SW11 after a lapse of a predetermined time period since turn-off of switch SW12, detected by voltage detector 11, and the on-time of switch SW22 is determined based on the voltage across switch SW21 after a lapse of a predetermined time period since turn-off of switch SW22, detected by voltage detector 12. That is, in the power converter according to the comparative example, the on-time of a target synchronous rectifier switch is not applied to the other synchronous rectifier switches, and on-times are determined independently for each phase.

Therefore, as shown in FIG. 12, each phase has a different period from turn-on of the control switch to the next turn-on of the control switch. In this case, soft switching can be realized in each of the two circuits, but it is difficult to maintain a phase shift of a fixed angle between the two circuits, and accordingly interleave operations are difficult to realize. Specifically, the phases of current peaks will overlap between the two phases and thereby output current ripple will increase.

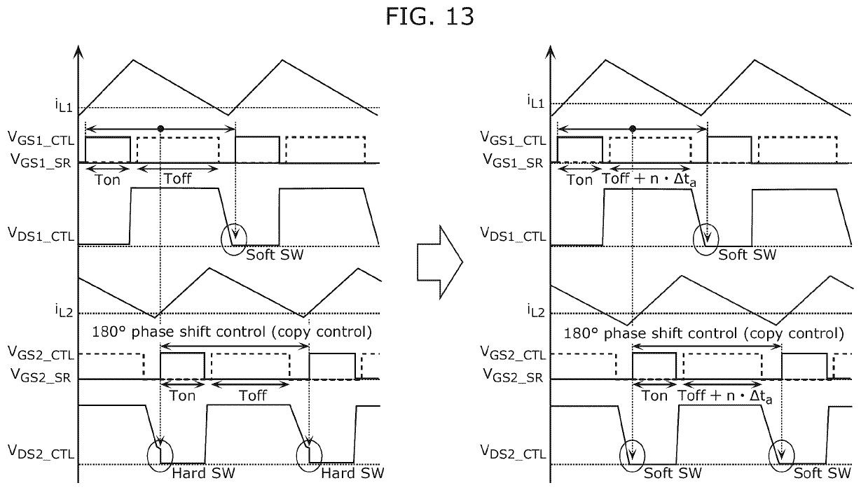

In contrast, power converter 3 is capable of appropriately performing soft switching for each phase. This is described with reference to FIG. 13.

FIG. 13 is a diagram for describing that soft switching can be performed appropriately for each phase of power converter 3 according to Embodiment 3.

Power converter 3 includes a voltage detector in each of the two circuits and determines the on-times of all of the synchronous rectifier switches in accordance with the voltage across a control switch that is in a hard switching state (in other words, the voltage across the control switch after a lapse of a predetermined time period has not yet stepped down to a target voltage). As shown on the left side in FIG. 13, for example, in the case where switch SW11 is in a soft switching state and switch SW21 is in a hard switching state, the on-times of all of the synchronous rectifier switches are determined based on a detection result of voltage detector 12. Accordingly, all of the synchronous rectifier switches have the same on-time, and it is possible to maintain a phase shift of a fixed angle between the two circuits.

As described above, for example, in the n-phase power converter, the n circuits basically use switches with parasitic capacitances of the same nominal value and inductors with inductances of the same nominal value. However, these parameters such as parasitic capacitances and inductances may vary even if they have the same nominal values. According to Embodiment 1, the on-time determined based on the voltage across switch SW11, detected by voltage detector 11, is applied to the on-times of all of the synchronous rectifier switches. Thus, if these parameters vary, soft switching may not be able to be realized in the circuit other than the circuit that includes voltage detector 11.

In view of this, according to Embodiment 3, the voltage detector is provided in each of the n circuits, and the on-times of all of the synchronous rectifier switches are determined based on the voltage across a control switch that is in a hard switching state. Accordingly, soft switching is realized in at least a control switch across which the voltage has been detected. In the case where there is sill another control switch that is in a hard switching state, the on-times of all of the synchronous rectifier switches are determined again based on the voltage across the control switch that is in a hard switching state, and this processing is repeated until all of the control switches enter a soft switching state. Accordingly, even if the aforementioned parameters vary, soft switching can be performed in each of the n circuits.

### Other Embodiments

As described above, embodiments have been described as illustrative examples of the technique according to the present disclosure. However, the technique according to the present disclosure is not intended to be limited to these embodiments and is also applicable to other embodiments obtained by appropriate modifications, replacements, addition, and omission. For example, the following variations are also included in one embodiment of the present disclosure.

For example, although the above-described embodiments have described examples in which the voltage detector includes the trigger signal generator, the dead-time detection signal generator, and the outputter, the present disclosure is not limited to these examples. For example, there are no particular limitations on the constituent elements of the voltage detector as long as the voltage detector has the function of detecting the voltage across a control switch after a lapse of a predetermined time period since turn-off of a synchronous rectifier switch.

For example, although the above-described embodiments have described examples in which the power converter is a step-down converter, the technique according to the present disclosure is also applicable to the case where the power converter is a step-up converter.

For example, the present disclosure can be realized not only as a power converter, but also as a method of controlling a power converter, the method including steps (processing) that are performed by the constituent elements of a power converter.

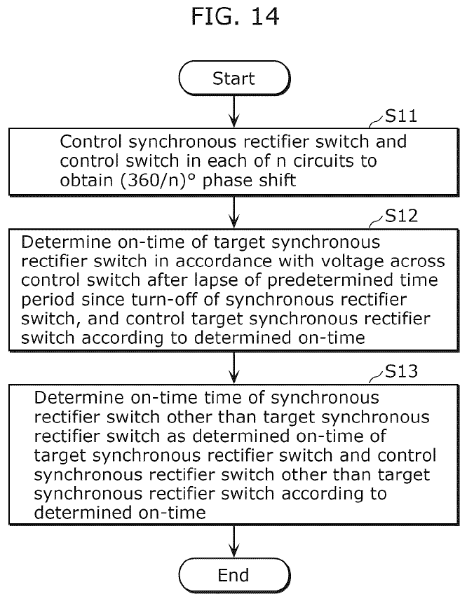

FIG. 14 is a flowchart showing one example of the control method according to another embodiment.

The control method is a method of controlling an interleaved n-phase power converter, where n is an integer greater than or equal to 2. The power converter includes n circuits each including a control switch provided in a first path that connects a first input/output terminal and a second input/output terminal, a synchronous rectifier switch provided in the first path and connected in series with the control switch, and an inductor provided in a second path that connects a third input/output terminal and a connection node provided in the first path between the control switch and the synchronous rectifier switch. One of the n circuits includes a voltage detector that detects a voltage across the control switch. As shown in FIG. 14, the control method includes controlling the control switch and the synchronous rectifier switch in each of the n circuits so that on and off phases of the control switch and the synchronous rectifier switch in the circuit are shifted by 360/n degrees from on and off phases in any other of the n circuits (step S11), determining the on-time of a target synchronous rectifier switch in accordance with a voltage across the control switch, the target synchronous rectifier switch being the synchronous rectifier switch in one of the n circuits, the voltage across the control switch being detected by the voltage detector after a lapse of a predetermined time period since turn-off of the synchronous rectifier switch (step S12), and determining the on-times of the synchronous rectifier switches of the n circuits other than the target synchronous rectifier switch as the determined on-time of the target synchronous rectifier switch and controlling the synchronous rectifier switches of the n circuits other than the target synchronous rectifier switches according to the determined on-time (step S13).

For example, the steps included in the control method may be executed by a computer (a computer system). Then, the present disclosure may be realized as a program for causing the computer to execute the steps included in the control method.

Moreover, the present disclosure may be realized as a non-transitory computer-readable recording medium such as a CD-ROM that has recorded thereon the program.

For example, in the case where the present disclosure is realized as a program (software), each step may be executed by the computer executing the program with use of hardware resources such as a CPU, memory, and an input/output circuit. That is, each step may be executed by the CPU acquiring and calculating data from, for example, the memory or the input/output circuit and outputting the result of calculation to, for example, the memory or the input/output circuit.

Each constituent element included in the power converters according to the aforementioned embodiments may be realized as a dedicated or general-purpose circuit.

Each constituent element included in the power converters according to the above-described embodiments may also be realized as a large-scale integration (LSI) circuit that is an integrated circuit (IC).

The integrated circuit is not limited to an LSI circuit, and may be realized by a dedicated circuit or a general-purpose processor. A field programmable gate array (FPGA) capable of programming or a reconfigurable processor capable of reconfiguring connections and settings of circuit cells inside an LSI circuit may also be used.

If any other circuit integration technique that replaces LSI makes its debut with the advance of semiconductor technology or with derivation from other technology, such a technique may be used to integrate each constituent element included in the power converter into a circuit.

The present disclosure also includes other embodiments obtained by making various modifications conceivable by those skilled in the art to the embodiments and embodiments realized by any combination of constituent elements and functions described in each embodiment without departing from the scope of the present disclosure.

### Appendixes

The following techniques are disclosed by the description of the above embodiments.

### Technique 1

An interleaved n-phase power converter, where n is an integer greater than or equal to 2 includes n circuits, the voltage detector, and the controller. Each of the n circuits includes a control switch provided in a first path that connects a first input/output terminal and a second input/output terminal, a synchronous rectifier switch provided in the first path and connected in series with the control switch, and an inductor provided in a second path that connects a third input/output terminal and a connection node provided in the first path between the control switch and the synchronous rectifier switch. The voltage detector detects a voltage across the control switch, the voltage detector being included in one of the n circuits. The controller controls the control switch and the synchronous rectifier switch in each of the n circuits to shift on and off phases of the control switch and the synchronous rectifier switch in the circuit by 360/n degrees from on and off phases of the control switch and the synchronous rectifier switch in an other of the n circuits. The controller determines an on time of a target synchronous rectifier switch in accordance with the voltage across the control switch and controls the target synchronous rectifier switch according to the on-time determined, the target synchronous rectifier switch being the synchronous rectifier switch in one of the n circuits, the voltage across the control switch being detected by the voltage detector after a lapse of a predetermined time period since turn-off of the synchronous rectifier switch, and determines an on-time of the synchronous rectifier switch in each of the n circuits other than the target synchronous rectifier switch as the on-time of the target synchronous rectifier switch determined, and controls the synchronous rectifier switch in each of the n circuits other than the target synchronous rectifier switch according to the on-time determined.

The period that the negative current flows through the inductor changes depending on the on-time of the synchronous rectifier switch, and the amount of step-down of the voltage across the control switch during the off state of the control switch and the synchronous rectifier switch is determined by the period that the negative current flows through the inductor. Thus, if the length of the on-time of the synchronous rectifier switch is adjusted and determined depending on whether the voltage across the control switch after a lapse of the predetermined time period from turn-on to turn off of the synchronous rectifier switch has stepped down to a target voltage, the control switch can be turned on when the voltage across the control switch is at the target voltage (e.g., 0V), i.e., soft switching is realized.

However, the n-phase power converter needs to maintain a phase shift of a fixed angle among the n circuits (e.g., 180° in the case of a two-phase power converter). For example, in the case where the on-time of the synchronous rectifier switch in each of the n circuits is determined independently, soft switching can be realized in the circuit, but it is difficult to maintain a phase shift of a fixed angle among the n circuits, and accordingly interleave operations are difficult to realize. According to the present disclosure, the on-time of the target synchronous rectifier switch in one of the n circuits is determined, and the determined on-time is also applied to the synchronous rectifier switches other than the target synchronous rectifier switch. Accordingly, the on-time of the synchronous rectifier switch in each of the n circuits changes by the same amount, and it is possible to maintain a phase shift of a fixed angle among the n circuits. Therefore, soft switching can be performed in each of the n circuits while a phase shift of a fixed angle is maintained among the n circuits. Accordingly, it is possible to provide an interleaved power converter capable of performing soft switching.

### Technique 2

The power converter according to Technique 1 includes the voltage detector in only one circuit among the n circuits, and (i) an inductance in the second path of the only one circuit that includes the voltage detector is greater than an inductance in the second path in each of the n circuits that does not include the voltage detector by an amount equivalent to a maximum variation tolerance of inductances of the inductors, or (ii) a capacitance across the control switch in the circuit that includes the voltage detector is greater than a capacitance across the control switch in each of the n circuits that does not include the voltage detector by an amount equivalent to a maximum variation tolerance of a parasitic capacitance of the control switch.

For example, in the n-phase power converter, the n circuits basically use switches with parasitic capacitances of the same nominal value and inductors with inductances of the same nominal value. However, these parameters such as parasitic capacitances and inductances may vary even if they have the same nominal values. According to the present disclosure, the on-time determined based on the voltage across the control switch, detected by voltage detector, is applied to the on-times of all of the synchronous rectifier switches. Thus, if these parameters vary, soft switching may not be able to be realized in the circuit other than the circuit that includes the voltage detector. In view of this, the inductance in the second path of the circuit that includes the voltage detector is made in advance greater than the inductance in the second path of the circuit that does not include the voltage detector by an amount equivalent to a maximum variation tolerance. Alternatively, the capacitance across the control switch in the circuit that includes the voltage detector is made in advance greater than the capacitance across the control switch in the circuit that does not include the voltage detector by an amount equivalent to a maximum variation tolerance. In this case, the period that the negative current flows through the inductor in the circuit that includes the voltage detector is shorter than in the circuit that does not include the voltage detector, and accordingly the control switch in the circuit that includes the voltage detector is prone to enter a hard switching state whereas the control switch in the circuit that does not include the voltage detector is hard to enter a hard switching state. Accordingly, the on-times of all of the synchronous rectifier switches are determined based on the voltage across the control switch that is prone to enter a hard switching state, and therefore even if the aforementioned parameters vary, it is possible to perform soft switching in each of the n circuits.

### Technique 3

In the power converter according to Technique 2, the only one circuit that includes the voltage detector further includes an additional capacitor connected in parallel with the control switch, and the additional capacitor has a capacitance equivalent to a maximum variation tolerance of the parasitic capacitance of the control switch in each of the n circuits that does not include the voltage detector.

In this way, the additional capacitor whose capacitance is equivalent to the maximum variation tolerance of the parasitic capacitance of the control switch is connected in parallel with the control switch in the circuit that includes the voltage detector. Therefore, the capacitance across the control switch in the circuit that includes the voltage detector can be made in advance greater than the capacitance across the control switch in the circuit that does not include the voltage detector by the amount equivalent to the maximum variation tolerance.

### Technique 4

In the power converter according to Technique 2 or 3, the only one circuit that includes the voltage detector further includes an additional inductor provided in the second path and connected in series with the inductor, and the additional inductor has an inductance equivalent to a maximum variation tolerance of an inductance of the inductor in each of the n circuits that does not include the voltage detector.

In this way, the additional inductor whose inductance is equivalent to the maximum variation tolerance of the inductances of the inductors provided in the second path is connected in series with the inductor in the circuit that includes the voltage detector. Therefore, the inductance in the second path of the circuit that includes the voltage detector can be made in advance greater than the inductor in the second path of the circuit that does not include the voltage detector by the amount equivalent to the maximum

### Technique 5

In the power converter according to Technique 1, the voltage detector is included in each of the n circuits, and the controller determines the on-time of the target synchronous rectifier switch in accordance with the voltage across the control switch detected by the voltage detector in each of the n circuits after a lapse of the predetermined time period since turn-off of the synchronous rectifier switch.

For example, in the n-phase power converter, the n circuits basically use switches with parasitic capacitances of the same nominal value and inductors with inductances of the same nominal value. However, these parameters such as parasitic capacitances and inductances may vary even if they have the same nominal values. According to the present disclosure, the on-time determined based on the voltage across the control switch, detected by the voltage detector, is applied to the on-times of all of the synchronous rectifier switches. Thus, if these parameters vary, soft switching may not be able to be realized in the circuit other than the circuit that includes the voltage detector. In view of this, the voltage detector is provided in each of the n circuits, and the on-times of all of the synchronous rectifier switches are determined based on the voltage across a control switch that is in a hard switching state (in other words, the voltage across the control switch after a lapse of a predetermined time period has not yet stepped down to a target voltage). Accordingly, soft switching can be realized in at least a control switch across which the voltage has been detected. The on-times of all of the synchronous rectifier switches are determined again based on the voltage across another control switch that is in a hard switching state, and this processing is repeated until all of the control switches enter a soft switching state. Accordingly, even if the aforementioned parameters vary, soft switching can be performed in each of the n circuits.

### Technique 6

In the power converter according to any one of Techniques 1 to 5, the controller determines the on-time of the target synchronous rectifier switch to be longer than a current on-time when the voltage detector has detected that the voltage across the control switch after a lapse of the predetermined time period since turn-off of the synchronous rectifier switch is greater than a predetermined threshold value, and determines the on-time of the target synchronous rectifier switch to be shorter than the current on-time when the voltage detector has detected that the voltage across the control switch after the lapse of the predetermined time period since the turn-off of the synchronous rectifier switch is less than or equal to the predetermined threshold value.

In the case where the voltage across the control switch after a lapse of the predetermined time period since turn off of the synchronous rectifier switch is greater than the predetermined threshold value, the control switch is in a hard switching state. Thus, soft switching can be realized by increasing the length of the on-time of the target synchronous rectifier switch. On the other hand, in the case where the voltage across the control switch after the lapse of the predetermined time period since the turn-off of the synchronous rectifier switch is less than or equal to the predetermined threshold value, the control switch is in a soft switching state, but a large negative current flows through the inductor and efficiency may decline. Thus, in this case, the on-time of the target synchronous rectifier switch is shortened so as to suppress a decline in efficiency caused by an increase in the negative current.

### Technique 7

In the power converter according to any one of Techniques 1 to 6, when a period from turn-on of the control switch to next turn-on of the control switch is defined as one switching cycle of the control switch, the controller determines the on-time of the target synchronous rectifier switch in a second switching cycle immediately after a first switching cycle in accordance with a detection result obtained in the first switching cycle by the voltage detector.

In this way, the detection result is reflected on the next switching cycle immediately after the switching cycle of voltage detection (i.e., the on-time determined based on the detection result is applied to all of the synchronous rectifier switches). This improves the response speed.

### Technique 8

In the power converter according to Technique 7, the controller determines the on-time of the target synchronous rectifier switch in the second switching cycle by adding a first correction amount to the on-time of the target synchronous rectifier switch in the first switching cycle.

In this way, by adding the first correction amount to the current on-time in each switching cycle, the on-time is gradually changed to an optimum on-time, and soft switching can be performed with high accuracy.

### Technique 9

In the power converter according to any one of Techniques 1 to 6, when a period from turn-on of the control switch to next turn-on of the control switch is defined as one switching cycle of the control switch and a cycle that includes a plurality of switching cycles, each of which is the one switching cycle, is defined as one control cycle, the controller determines the on-time of the target synchronous rectifier switch in a second control cycle immediately after a first control cycle in accordance with a detection result obtained in the first control cycle by the voltage detector.

In this way, the detection result is reflected on the next control cycle immediately after the control cycle of voltage detection (i.e., the on-time determined based on the detection result is applied to all of the synchronous rectifier switches). This improves the response speed.

### Technique 10

In the power converter according to Technique 9, the controller determines the on-time of the target synchronous rectifier switch in the second control cycle by adding a first correction amount to the on-time of the target synchronous rectifier switch in the first control cycle.

In this way, by adding the first correction amount to the current on-time in each control cycle, the on-time is gradually changed to an optimum on-time, and soft switching can be performed with high accuracy.

### Technique 11

In the power converter according to any one of Techniques 1 to 6, when a period from turn-on of the control switch to next turn-on of the control switch is defined as one switching cycle of the control switch and a cycle that includes a plurality of switching cycles, each of which is the one switching cycle, is defined as one control cycle, the controller performs, in a second control cycle immediately after a first control cycle, an arithmetic operation for determining the on-time of the target synchronous rectifier switch in a third control cycle immediately after the second control cycle in accordance with a detection result obtained in the first control cycle by the voltage detector.

In this way, the arithmetic operation for reflecting the detection result on the next control cycle is performed in a control cycle immediately after the control cycle of voltage detection. This ensures a sufficient amount of arithmetic time.

### Technique 12

In the power converter according to any one of Techniques 1 to 11, the voltage detector includes a trigger signal generator that generates a trigger signal after a lapse of the predetermined time period since turn-off of the synchronous rectifier switch, a dead-time detection signal generator that generates a dead-time detection signal when the voltage across the control switch is less than or equal to a predetermined threshold value, and an outputter that outputs a soft-switch detection signal for determining the on-time of the target synchronous rectifier switch in accordance with the trigger signal and the dead-time detection signal.

Accordingly, in the case where the dead-time detection signal is generated with the timing of generation of the trigger signal, it is determined that the control switch is in a soft switching state. In the case where the dead-time detection signal is not generated with the timing of generation of the trigger signal, it is determined that the control switch is in a hard switching state.

### Technique 13

In the power converter according to any one of Techniques 1 to 12, the predetermined time period is a period in which the control switch and the synchronous rectifier switch are off, a negative current flows through the inductor, and resonance is produced by an inductance of the inductor, a capacitance across the control switch, and a capacitance across the synchronous rectifier switch.

By setting the predetermined time period to such a period that has a physical meaning, it is possible to perform soft switching with high accuracy.

### Technique 14

A control method is a control method of controlling a power converter that is an interleaved n-phase power converter, where n is an integer greater than or equal to 2. The power converter includes n circuits and a voltage detector. Each of the n circuits includes a control switch provided in a first path that connects a first input/output terminal and a second input/output terminal, a synchronous rectifier switch provided in the first path and connected in series with the control switch, and an inductor provided in a second path that connects a third input/output terminal and a connection node provided in the first path between the control switch and the synchronous rectifier switch. The voltage detector detects a voltage across the control switch, the voltage detector being included in one of the n circuits. The control method includes controlling the control switch and the synchronous rectifier switch in each of the n circuits to shift on and off phases of the control switch and the synchronous rectifier switch in each of the n circuits by 360/n degrees from on and off phases of the control switch and the synchronous rectifier switch in an other of the n circuits, determining an on-time of a target synchronous rectifier switch in accordance with the voltage across the control switch and controlling the target synchronous rectifier switch according to the on-time determined, the target synchronous rectifier switch being the synchronous rectifier switch in one of the n circuits, the voltage across the control switch being detected by the voltage detector after a lapse of a predetermined time period since turn-off of the synchronous rectifier switch, and determining an on-time of the synchronous rectifier switch in each of the n circuits other than the target synchronous rectifier switch as the on-time of the target synchronous rectifier switch determined, and controlling the synchronous rectifier switch in each of the n circuits other than the target synchronous rectifier switch according to the on-time determined.

By using this control method to control the power converter, it is possible to provide an interleaved power converter capable of performing soft switching.

### Industrial Applicability

The present disclosure is applicable to an interleaved power converter or the like.

### Reference Signs List

1, 2, 3 power converter
10 controller
11, 12 voltage detector
C11, C11a, C12, C21, C22 capacitor
L1, L1a, L2 inductor
N1 connection node
P1, P2 path
SW11, SW12, SW21, SW22 switch
t1, t2, t3 input/output terminal

1. A power converter that is an interleaved n-phase power converter, where n is an integer greater than or equal to 2, the power converter comprising:
n circuits each including:
a control switch provided in a first path that connects a first input/output terminal and a second input/output terminal;
a synchronous rectifier switch provided in the first path and connected in series with the control switch; and
an inductor provided in a second path that connects a third input/output terminal and a connection node provided in the first path between the control switch and the synchronous rectifier switch;
a voltage detector that detects a voltage across the control switch, the voltage detector being included in one of the n circuits; and
a controller that controls the control switch and the synchronous rectifier switch in each of the n circuits to shift on and off phases of the control switch and the synchronous rectifier switch in the circuit by 360/n degrees from on and off phases of the control switch and the synchronous rectifier switch in an other of the n circuits,
wherein the controller:
determines an on time of a target synchronous rectifier switch in accordance with the voltage across the control switch and controls the target synchronous rectifier switch according to the on-time determined, the target synchronous rectifier switch being the synchronous rectifier switch in one of the n circuits, the voltage across the control switch being detected by the voltage detector after a lapse of a predetermined time period since turn-off of the synchronous rectifier switch; and
determines an on-time of the synchronous rectifier switch in each of the n circuits other than the target synchronous rectifier switch as the on-time of the target synchronous rectifier switch determined, and controls the synchronous rectifier switch in each of the n circuits other than the target synchronous rectifier switch according to the on-time determined.

2. The power converter according to claim 1,
wherein the power converter includes the voltage detector in only one circuit among the n circuits, and
(i) an inductance in the second path of the only one circuit that includes the voltage detector is greater than an inductance in the second path in each of the n circuits that does not include the voltage detector by an amount equivalent to a maximum variation tolerance of inductances of the inductors, or (ii) a capacitance across the control switch in the circuit that includes the voltage detector is greater than a capacitance across the control switch in each of the n circuits that does not include the voltage detector by an amount equivalent to a maximum variation tolerance of a parasitic capacitance of the control switch.

3. The power converter according to claim 2,
wherein the only one circuit that includes the voltage detector further includes an additional capacitor connected in parallel with the control switch, and
the additional capacitor has a capacitance equivalent to a maximum variation tolerance of the parasitic capacitance of the control switch in each of the n circuits that does not include the voltage detector.

4. The power converter according to claim 2,
wherein the only one circuit that includes the voltage detector further includes an additional inductor provided in the second path and connected in series with the inductor, and
the additional inductor has an inductance equivalent to a maximum variation tolerance of an inductance of the inductor in each of the n circuits that does not include the voltage detector.

5. The power converter according to claim 1,
wherein the voltage detector is included in each of the n circuits, and
the controller determines the on-time of the target synchronous rectifier switch in accordance with the voltage across the control switch detected by the voltage detector in each of the n circuits after a lapse of the predetermined time period since turn-off of the synchronous rectifier switch.

6. The power converter according to claim 1,
wherein the controller:
determines the on-time of the target synchronous rectifier switch to be longer than a current on-time when the voltage detector has detected that the voltage across the control switch after a lapse of the predetermined time period since turn-off of the synchronous rectifier switch is greater than a predetermined threshold value; and
determines the on-time of the target synchronous rectifier switch to be shorter than the current on-time when the voltage detector has detected that the voltage across the control switch after the lapse of the predetermined time period since the turn-off of the synchronous rectifier switch is less than or equal to the predetermined threshold value.

7. The power converter according to claim 1,
wherein, when a period from turn-on of the control switch to next turn-on of the control switch is defined as one switching cycle of the control switch, the controller determines the on-time of the target synchronous rectifier switch in a second switching cycle immediately after a first switching cycle in accordance with a detection result obtained in the first switching cycle by the voltage detector.

8. The power converter according to claim 7,
wherein the controller determines the on-time of the target synchronous rectifier switch in the second switching cycle by adding a first correction amount to the on-time of the target synchronous rectifier switch in the first switching cycle.

9. The power converter according to claim 1,
wherein, when a period from turn-on of the control switch to next turn-on of the control switch is defined as one switching cycle of the control switch and a cycle that includes a plurality of switching cycles, each of which is the one switching cycle, is defined as one control cycle, the controller determines the on-time of the target synchronous rectifier switch in a second control cycle immediately after a first control cycle in accordance with a detection result obtained in the first control cycle by the voltage detector.

10. The power converter according to claim 9,
wherein the controller determines the on-time of the target synchronous rectifier switch in the second control cycle by adding a first correction amount to the on-time of the target synchronous rectifier switch in the first control cycle.

11. The power converter according to claim 1,
wherein, when a period from turn-on of the control switch to next turn-on of the control switch is defined as one switching cycle of the control switch and a cycle that includes a plurality of switching cycles, each of which is the one switching cycle, is defined as one control cycle, the controller performs, in a second control cycle immediately after a first control cycle, an arithmetic operation for determining the on-time of the target synchronous rectifier switch in a third control cycle immediately after the second control cycle in accordance with a detection result obtained in the first control cycle by the voltage detector.

12. The power converter according to claim 1,
wherein the voltage detector includes:
a trigger signal generator that generates a trigger signal after a lapse of the predetermined time period since turn-off of the synchronous rectifier switch;
a dead-time detection signal generator that generates a dead-time detection signal when the voltage across the control switch is less than or equal to a predetermined threshold value; and
an outputter that outputs a soft-switch detection signal for determining the on-time of the target synchronous rectifier switch in accordance with the trigger signal and the dead-time detection signal.

13. The power converter according to claim 1,
wherein the predetermined time period is a period in which:
the control switch and the synchronous rectifier switch are off;
a negative current flows through the inductor; and
resonance is produced by an inductance of the inductor, a capacitance across the control switch, and a capacitance across the synchronous rectifier switch.

14. A control method of controlling a power converter that is an interleaved n-phase power converter, where n is an integer greater than or equal to 2,
the power converter including:
n circuits each including:
a control switch provided in a first path that connects a first input/output terminal and a second input/output terminal;
a synchronous rectifier switch provided in the first path and connected in series with the control switch; and
an inductor provided in a second path that connects a third input/output terminal and a connection node provided in the first path between the control switch and the synchronous rectifier switch; and
a voltage detector that detects a voltage across the control switch, the voltage detector being included in one of the n circuits,
the control method comprising:
controlling the control switch and the synchronous rectifier switch in each of the n circuits to shift on and off phases of the control switch and the synchronous rectifier switch in each of the n circuits by 360/n degrees from on and off phases of the control switch and the synchronous rectifier switch in an other of the n circuits;
determining an on-time of a target synchronous rectifier switch in accordance with the voltage across the control switch and controlling the target synchronous rectifier switch according to the on-time determined, the target synchronous rectifier switch being the synchronous rectifier switch in one of the n circuits, the voltage across the control switch being detected by the voltage detector after a lapse of a predetermined time period since turn-off of the synchronous rectifier switch; and
determining an on-time of the synchronous rectifier switch in each of the n circuits other than the target synchronous rectifier switch as the on-time of the target synchronous rectifier switch determined, and controlling the synchronous rectifier switch in each of the n circuits other than the target synchronous rectifier switch according to the on-time determined.
